(19) United States
(12) Patent Application Publication
(10) Pub. No.: US 2007/0273750 A1
(43) Pub. Date: Nov. 29, 2007

(54) Camera phone and photography support method used for the camera phone

(75) Inventor: Hideya Tanaka, Kanagawa (JP)

Correspondence Address: YOUNG & THOMPSON, 745 SOUTH 23RD STREET, 2ND FLOOR, ARLINGTON, VA, 22202, US

(73) Assignee: NEC ELECTRONICS CORPORATION, Kanagawa (JP)

(21) Appl. No.: 11/797,958

(22) Filed: May 9, 2007

(30) Foreign Application Priority Data
May 15, 2006 (JP) 2006-135782

(51) Int. Cl. H04N 7/14

(52) U.S. Cl. 348/14.01

(57) ABSTRACT

A camera phone according to an embodiment of the present invention supports a user to obtain the optimum amount of images to generate a composite image based on captured images through mosaicing processing or super-resolution processing. For that purpose, the camera phone includes a photography condition analyzing unit for analyzing current photography conditions. The photography condition analyzing unit includes a motion detecting unit for detecting a moving speed. If the detected moving speed is not within a predetermined range, for example, a speaker gives warning beeps to inform a user of this situation.

### BACKGROUND OF THE INVENTION

1. Field of the Invention

The present invention relates to a camera phone for capturing images to generate a composite image, a method of controlling the camera phone, and a photography support method used for the camera phone.

2. Description of Related Art

Mosaicing processing was originally used as a technique of combining analog still images such as air photography after photographing. Digital cameras were developed afterwards, and mosaicing processing based on digital processing was realized. Further, in addition to the field of air photography, the mosaicing processing had been modified as a technique of precisely controlling a camera position to seamlessly combine still images. After that, the mosaicing technique for still images has developed to mosaicing processing for moving pictures. However, even at the time of combining the moving pictures, a camera position should be still controlled.

To that end, a mosaicing technique directed at a camera phone the position of which cannot be precisely controlled because of its handheld shape, has been recently under study. This technique performs mosaicing processing as post processing after capturing moving pictures based on moving-picture compression such as an MPEG (Moving Picture Experts Group), or mosaicing processing together with super-resolution processing (for example, see Japanese Unexamined Patent Application Publication Nos. 11-234501 and 2005-20761).

Nowadays, in the case of saving or transferring texts written on paper or photographs in the form of digitalized image data, image data is generally obtained with a flat head scanner or the like. However, such scanner is large and not easily portable. Thus, if the image data could be obtained with a camera-equipped device such as a camera phone, a user can easily obtain high-definition images. However, a resolution of an image captured with a general camera-equipped device is much lower than that of the flat head scanner on the assumption that a substantially A4-sized sheet is photographed at a time.

To that end, THE IEICE TRANSACTIONS ON INFORMATION AND SYSTEMS, PT.2, Vol. J88-D-II, No. 8, pp. 1490-1498, August 2005, reports a technique of executing mosaicing and super-resolution processings on moving pictures captured with a camera-equipped device to obtain a high-definition image. The above technique is directed to print including texts and images.

A general camera phone for such mosaicing and super-resolution processings is now described. FIG. 6 is a block diagram of the general camera phone. A portable device 500 includes a photographic camera 510, an image compressing unit 520 for compressing an image taken with the camera 510, and an auxiliary storage 550 for storing the compressed image. The device 500 further includes an image decompressing unit 530 for decompressing and decoding the compressed image and a display 580 for displaying the decoded image. Further, the device 500 includes a keyboard 590 via which a user enters instructions, a speaker 540 that outputs sounds, a memory 570, and a CPU 560. The above units are connected with each other via bus lines. Such a camera phone carries out mosaicing processing and super-resolution processing based on moving pictures captured with the camera 510 under the control of the CPU 560.

FIG. 7 is a flowchart of a mosaicing and super-resolution processing method. As shown in FIG. 7, moving pictures are first taken (step S101). After the completion of photographing (step S102: Yes), mosaicing processing and super-resolution processing are carried out (step S103, 104). Upon the completion of processing all of target images (step S105), the processing is ended.

However, the mosaicing processing or super-resolution processing with the camera-equipped portable device has the following problem. That is, as for the mosaicing processing, if a target image is, for example, a rectangular image such as print, the entire image should be captured. In general, a user relies on memory or follows one's hunches to confirm a photographed area. Thus, if an inexperienced user uses the device, areas remain unphotographed, with the result that mosaicing processing for a target area cannot be finished, and a desired mosaic image cannot be obtained.

Further, in a super-resolution processing, unless a predetermined number of images are captured in the same area, proper processing cannot be executed. However, it is difficult to exactly know how many images are captured at the present time based on manual user's operations. In some cases, images would be captured more than necessary.

That is, even if a composite image is generated through predetermined processing such as mosaicing processing or super-resolution processing, it is uncertain how many images are necessary, leading to a problem that the number of captured images is too small or large. If the number of captured images is small and an unphotographed area remains, mosaicing processing or super-resolution processing cannot be executed. On the other hand, if the number of captured images is too large, there are a problem in that a memory capacity for storing the images is increased, and a problem in that post-processing such as mosaicing processing or super-resolution processing takes much time to execute.

To overcome the above problems, Japanese Unexamined Patent Application Publication No. 2004-96156 (Sugioka et al.) discloses an image synthesizing method and an image synthesizing system, which enable real-time visual determination as to whether photography succeeds or ends in failure, that is, whether or not a composite image can be generated. In the image synthesizing method of Sugioka et al., plural taken images are captured, composed, and displayed to thereby check a composite image of the plural captured images on the spot to determine whether or not image synthesis can be executed.

However, in the image synthesizing method of Sugioka et al., it is necessary to generate a composite image for determining whether or not image synthesis can be executed, so a photographing device needs to have an image synthesizing function. This image synthesizing function for checking whether or not image synthesis can be executed and generating a composite image if possible hinders downsizing and cost-saving especially in a portable device.

### SUMMARY OF THE INVENTION

A camera phone according to an aspect of the present invention includes: a camera capturing an image; a motion detecting unit detecting a moving speed of the camera phone upon capturing images to generate a composite image; and an informing unit informing a user of a detecting result from the motion detecting unit. The camera phone captures the images to generate the composite image. According to the present invention, the motion detecting unit detects a moving speed of the camera phone to inform a user of the detection result to easily adjust the moving speed to the optimum speed.

According to the present invention, it is possible to provide a camera phone and a photography support method used for the camera phone, which can support a user to capture a proper number of images to generate various composite images of the captured images in a simpler manner.

### BRIEF DESCRIPTION OF THE DRAWINGS

The above and other objects, advantages and features of the present invention will be more apparent from the following description taken in conjunction with the accompanying drawings, in which:

FIG. 1 is a block diagram of a camera phone according to an embodiment of the present invention;

FIG. 2 shows a photography condition analyzing unit and its peripheral blocks of the camera phone according to the embodiment of the present invention;

FIG. 3 illustrates motion information used in the camera phone according to the embodiment of the present invention;

FIG. 4 shows a camera movement path of the camera phone according to the embodiment of the present invention;

FIG. 5 is a flowchart of operations of the camera phone according to the embodiment of the present invention;

FIG. 6 is a block diagram of a general camera phone; and

FIG. 7 is a flowchart of operations of the general camera phone.

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposes.

Embodiments of the present invention are described below in detail with reference to the accompanying drawings. Precise positional control on a transportable mobile device such as a camera phone, a digital camera, or a digital video camera is difficult, for instance. The following embodiment enables formation of a composite image by notifying a user of a photographed area even in such portable device the position of which cannot be precisely controlled, to thereby aid in photography upon forming the composite image.

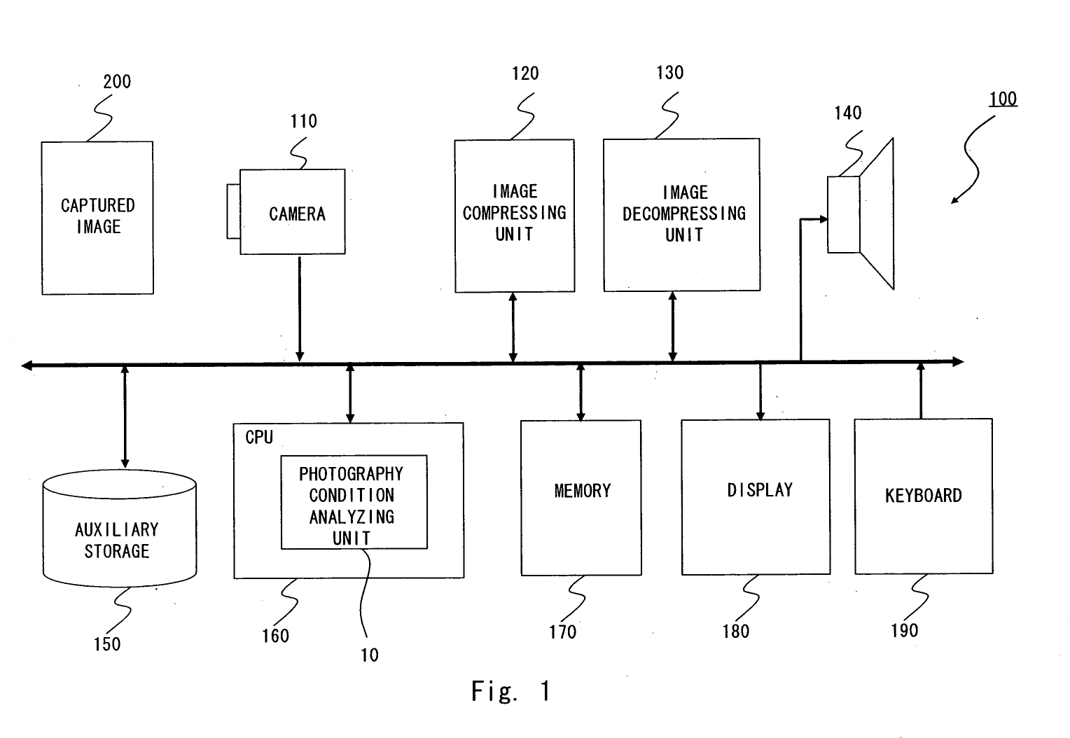

FIG. 1 is a block diagram of a camera phone according to an embodiment of the present invention. As shown in FIG. 1, a camera phone 100 includes a camera 110 for taking an image, an image compressing unit 120 for encoding and compressing the image taken with the camera 110, and an image decompressing unit 130 for decompressing and decoding the compressed image. Further, the camera phone 100 includes a speaker 140 for outputting sounds, an auxiliary storage 150 storing a taken image, a CPU 160, a memory 170 storing programs or the like, a display 180 displaying a taken image, and a keyboard 190 via which a enters instructions and the like.

The above camera phone 100 compresses an image 200 taken with the camera 110 by the image compressing unit 120 and stores the compressed image in the auxiliary storage 150. In addition, the taken image stored in the auxiliary storage 150 is decompressed and decoded with the image decompressing unit 130 and then displayed on the display 180. The image compressing unit 120 and the image decompressing unit 130 are software which are driven by the CPU 160 reading and executing programs stored in the memory 170 or the auxiliary storage 150.

In addition, if sounds as well as images are recorded, the images are displayed on the display 180 and at the same time, the sounds are output from the speaker 140. In addition, the speaker 140 can additionally output button sounds or alert sounds. In addition, the display 180 and the speaker 140 of this embodiment function as a photographing condition notifying unit for notifying a user of a current photographing condition during or after photography as described below.

The keyboard 190 is an input unit via which a user enters instructions. For example, a command to start photography, a command to end photography, a delete command, a save command, an edit command, or the like can be input. In response to the user's instructions, the CPU 160 controls each block, reads necessary programs from the memory 170, and executes various operations based on programs.

Here, the camera phone 100 of this embodiment includes a photographing condition analyzing unit 10 for analyzing current photographing conditions for aiding a user in photography. The photographing condition analyzing unit 10 is a software that is driven by the CPU 160 reading and executing programs stored in the memory 170 or the auxiliary storage 150.

The photographing condition analyzing unit 10 is a processing unit for aiding a user in obtaining images necessary for generating a composite image through, for example, mosaicing processing or super-resolution processing. As described in detail below, this unit helps a user obtain necessary images during or after photography or sends an error notification to aid the user in obtaining a composite image.

For example, if mosaicing processing and super-resolution processing are carried out in combination, high-definition digital image data can be obtained even for a poster, print, or other such area larger than the angle of field of the camera, or an area whose image becomes indistinct if the entire area is photographed. A post processing unit (not shown) executing the mosaicing processing or the super-resolution processing is realized by the CPU 160 based on a captured image. The following description is made on the assumption that mosaicing and super-resolution processings are carried out on images of flat and rectangular areas for ease of explanation. In addition, the mosaicing and/or the super-resolution processing is referred to as “post processing”. Further, a rectangular area subjected to the post processing is referred to as a target area. Incidentally, an area to be photographed, that is, an area subjected to mosaicing and super-resolution processings may be, of course, a non-rectangular area or a non-flat area such as a landscape image.

Here, the mosaicing processing and super-resolution processing are described in brief. A mosaicing processing technique of combining plural partial images captured with a small camera to compose the images is combined with a super-resolution processing technique of generating a high-definition image based on a superimposed image of moving pictures, making it possible to read an A4-sized text with a camera of a camera phone or the like, for example, in place of a scanner. The mosaicing processing generates a wide-field image (mosaic image) of a subject that is flat or seemingly almost flat like a long-distance view, which exceeds the original angle of view of the camera. If the entire subject image cannot be taken by the camera, the subject is partially photographed plural times in different camera positions and orientations. The captured images are combined to generate the whole subject image.

In addition, the super-resolution processing combines plural images obtained by photographing a subject with the angle changed a little to assume/reconstruct data on details of a subject to generate a high-definition image beyond the intrinsic performance of the camera. In a super-resolution technique as disclosed in Japanese Unexamined Patent Application Publication No. 11-234501, a part of a subject is photographed while the camera position is changed and movements in moving pictures are analyzed to estimate camera movements such as a three-dimensional position of the camera or image-taking direction upon capturing each frame image on real time. Based on the estimated result, the mosaicing processing is carried out. Thus, a mosaic image can be taken while a camera is held in hand and freely moved without using a special camera scanning mechanism or positional sensor. Further, high image quality equivalent to a quality of an image read with a scanner is realized through super-resolution processing based on high-definition camera movement estimation.

Incidentally, to obtain correct results of the post processing, it is necessary to photograph the whole area of the target area with a proper amount. That is, if a captured image amount is too small, post-processing cannot be executed or even if executed, high-quality images cannot be obtained. However, in manual operations, a moving speed of the camera 110 should be determined based on use's guess. In this case, if a user is not accustomed to use a camera, there is a fear that a moving speed is set too high, and information necessary for the processing cannot be obtained. As a result, a desired super-resolution effect cannot be expected.

On the other hand, if the moving speed of the camera 110 is too low, a photographing period is elongated and image information is captured more than necessary. As a result, it takes much time to capture moving pictures. In addition, a larger data capacity is required of the auxiliary storage 150 to store the thus-captured images because of the long photographing period. Furthermore, mosaicing processing and super-resolution processing should be carried out on more information than necessary, resulting in a problem that processing time thereof is long, and the total processing time is increased.

To that end, the photographing device of this embodiment is provided with a photography condition analyzing unit 10 to aid a user to set a camera-phone moving speed optimum for photographing a target area to obtain a proper amount of images during and after photography. The user is thereby supported to capture the optimum amount of images for post-processing. Further, if there is little probability that a correct result is obtained due to very high moving speed of the camera phone, information that encourages a user to photograph the area again may be provided.

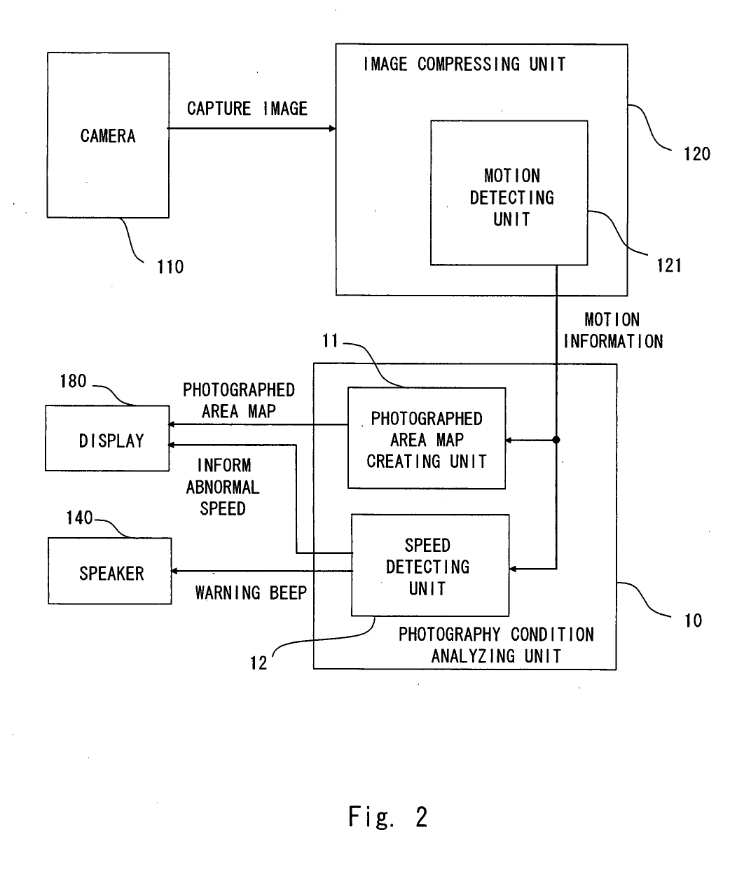

Next, the photographing result analysis executed by the photographing condition analyzing unit 10 is described in more detail. The following description is made of an example where the camera 110 captures moving pictures to subject the moving pictures to the post processing to obtain a composite image. Incidentally, this embodiment describes moving pictures by way of example, but a composite image may be generated based on plural still images. FIG. 2 shows the photographing condition analyzing unit 10 and its peripheral blocks. The photographing condition analyzing unit 10 of this embodiment includes a photographed area map creating unit 11 for creating a photographed area map based on motion information from a motion detecting unit 121 of the image compressing unit 120, and a mask image generating unit 12 for generating a composite image based on the created photographed area map.

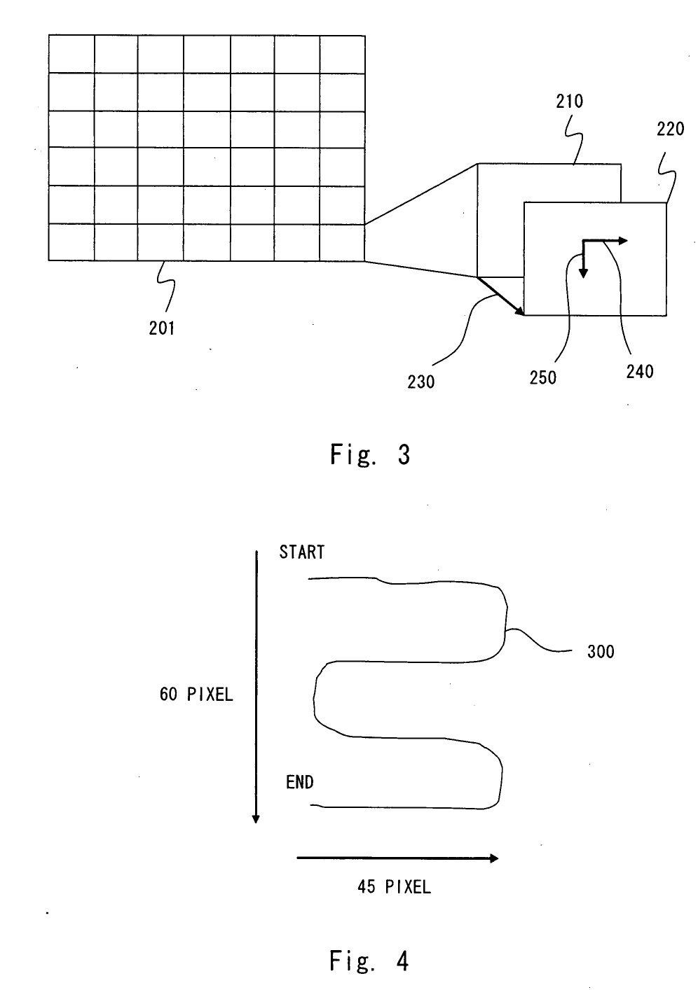

Here, the image compressing unit 120 executes, for example, well-known image compression such as MPEG to compress a captured image. In this case, the image compressing unit 120 divides the entire photography area of the camera 110 into several macro blocks to execute processing for each block. FIG. 3 illustrates moving picture processing. In a photography area 201, a macro block 210 at a given point of time is compared with a macro block 220 after the elapse of Δ period 230 to calculate a displacement 240 in the X-axis direction and a displacement 250 in the Y-axis direction. In this example, the displacement 240 in the X-axis direction and the displacement 250 in the Y-axis direction may be calculated based on one macro block or obtained by averaging displacements of all macro blocks or by extracting specific macro blocks at the corner or center to average the displacements of these blocks. The motion detecting unit 121 of the image compressing unit 120 calculates the displacements 240 and 250, and the image compressing unit 120 compresses moving pictures based on the displacements 240 and 250.

The speed detecting unit 11 of this embodiment receives the displacements 240 and 250 from a motion detecting unit 121. Then, the unit calculates a moving speed of the camera 110 based on the motion information. That is, an X-directional displacement 240, a Y-directional displacement 250, and Δ time 230 are obtained upon capturing moving images of a target area. Then, the moving speed of the camera 110 is calculated and compared with a proper camera moving speed based on these information. If the moving speed in question is not within the proper moving speed range, an error message is displayed on a display 180 or a speaker 140 gives warning beeps to inform a user that the speed is abnormal.

In general, the camera phone includes an image compressing unit 120 or similar image compressing unit to obtain motion information. In this way, motion information is obtained with the in-built image compressing unit 120 to calculate movement and in turn a moving speed. Hence, it is unnecessary to provide a motion information detecting unit or the like as an additional function. Further, as for a photographing speed for the optimum amount of moving images for post-processing, a speed range (upper limit and lower limit) is preset by experiment. Incidentally, a proper speed may be set or reset through plural user operations.

Further, the photographed area map creating unit 11 obtains the above motion information to thereby obtain information about the areas that have been captured at present time during photography or information about the whole captured areas after photography. FIG. 4 shows information about photography area. The photographed area map creating unit 11 of this embodiment derives the locus 300 of a fixed point such as the center point of a photography area of the camera based on the displacements 240 and 250 as information about a photography area.

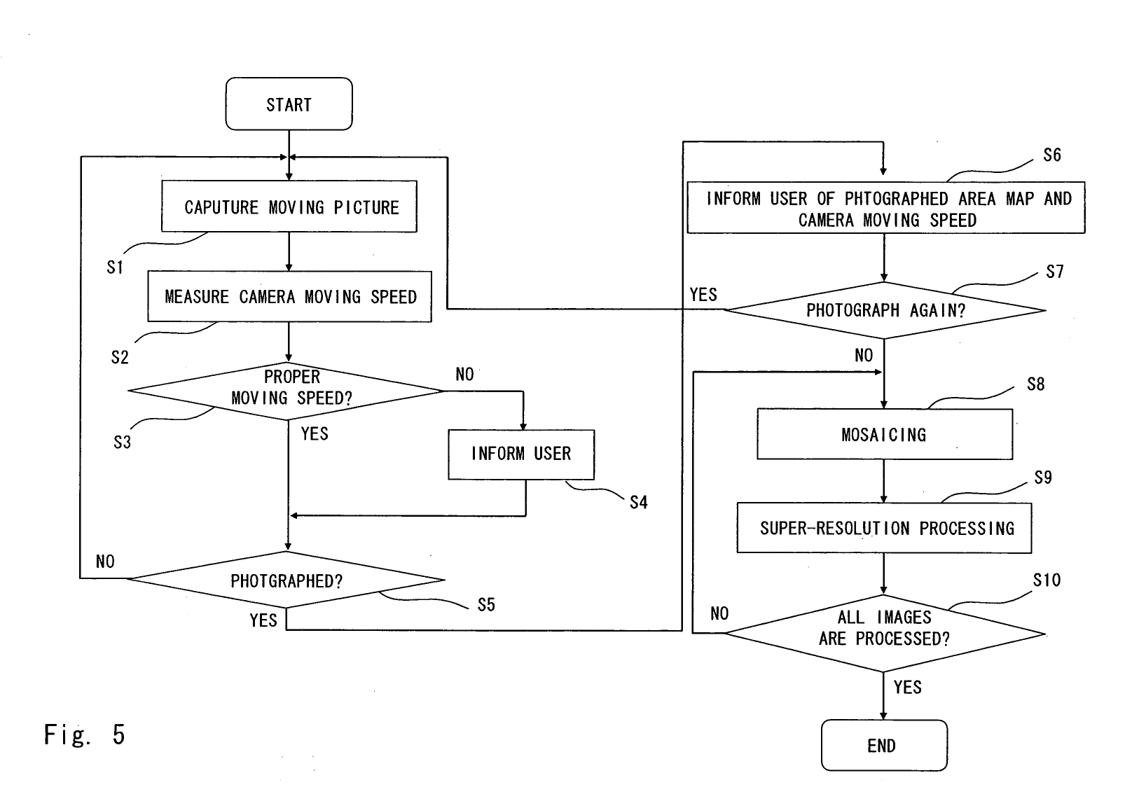

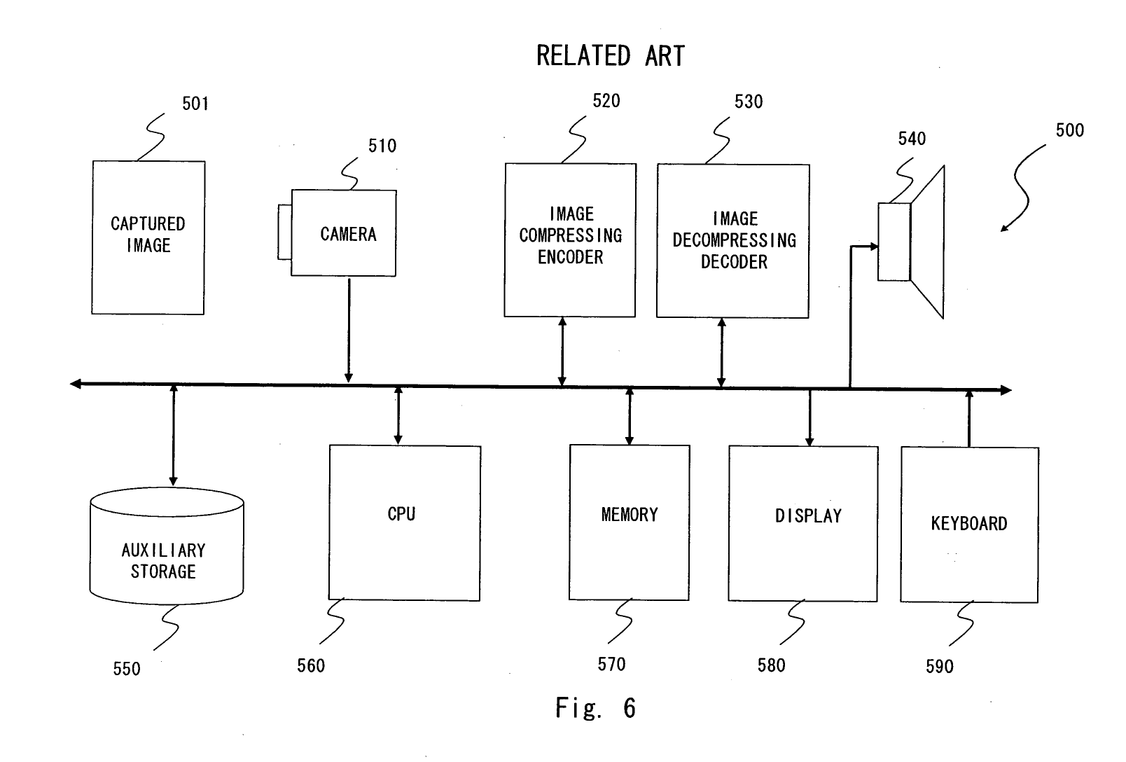

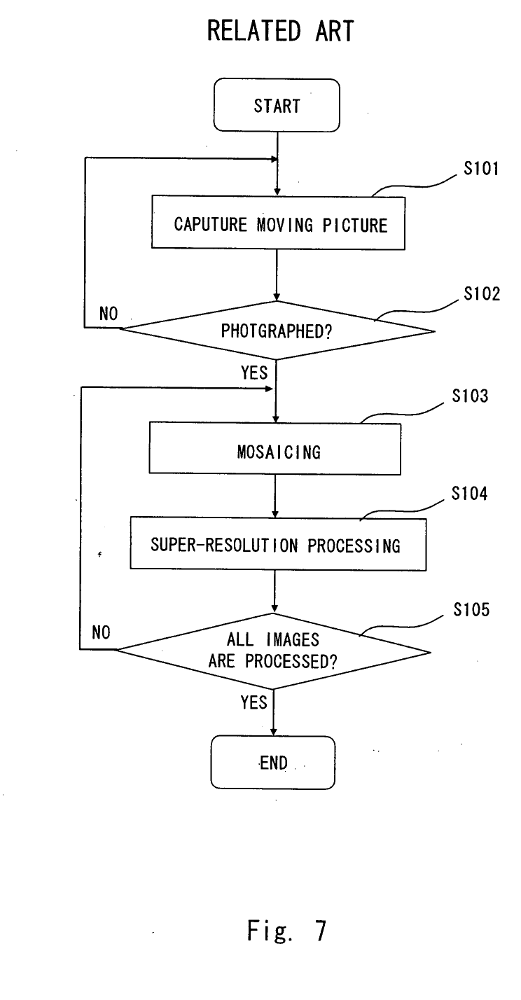

FIG. 5 is a flowchart of operations of this embodiment. As shown in FIG. 5, a post-processing-target area is first photographed to obtain moving images (step S1). Then, the motion detecting unit 12 obtains motion information based on the processing result from the motion detecting unit 121 of the image compressing unit 120 to measure a moving speed of the camera 110 (step S2). If the measured moving speed is not within a proper speed range (step S3: No), a user is informed of abnormal moving speeds through the speaker 140 or display 180 (step S4). A user continues photographing until the target area is photographed, and the motion detecting unit 12 monitors the moving speed to support the user to control the camera moving speed into a proper range.

After the completion of photographing, the photography locus is displayed to create a map representing a photographed area as shown in FIG. 4, for example, with the photographed-area creating unit 11, and the map is displayed on the display 180 (step S6). At this time, in this embodiment, an average camera moving speed or the like may be displayed together with the photographed area map. Incidentally, in this embodiment, an abnormal moving speed is informed to a user and in addition, the photographed area map is displayed on the display 180 during photography and after photography. However, only an abnormal moving speed is informed to a user to realize the optimum photographing amount without displaying a photographed area. Further, in this embodiment, the information about the moving speed is output from the speaker 140 or displayed on the display 180. However, this information may be output or displayed only during or after photography. After that, if the user determines that a desired number of images of a target area are obtained (step S7: Yes), mosaicing processing, super-resolution processing is executed based on the captured images to generate a composite image (steps S8 to S10).

According to this embodiment, if the moving speed of the camera 110 is too high to obtain the optimum amount of images for post-processing, that is, information amount would be insufficient, warning beep or message is given to inform a user of this situation. Further, if the moving speed is too low to obtain the optimum amount of images for post processing, that is, post-processing amount and time would increase due to an excessive amount of information, and a large storage capacity would be necessary for saving captured moving images, warning beep or message is given to inform a user of this situation. As a result, a proper moving speed is visually and acoustically informed to the user to thereby capture moving images with the camera moving speed appropriate for post processing such as super-resolution processing without relying on user's memory or hunches.

That is, in general, a user does not need to rely on memory or follow one's hunches to control the moving speed of a handy camera phone. Thus, if the camera moving speed is too high to obtain data enough for processing, or if information is obtained more than necessary due to very low camera moving speeds. In contrast, if the camera moving speed is outside the preset speed range, a user is informed of this situation to thereby move a camera at a proper moving speed to reduce failures during photography.

Further, in this embodiment, the proper camera moving speed is-preset, the range can be changed. That is, although a larger image amount requires longer processing time, a high-quality composite image can be obtained. Hence, the upper and lower limits of the proper camera moving speed may be set variable to allow a user to select a quality of a composite image obtained through post processing before capturing moving images to set the upper and lower limits of the proper camera moving speed in accordance with the quality level.

Further, in this embodiment, whether or not the camera moving speed is proper is informed to a user with warning beeps from the speaker or warning messages displayed on the display. Instead, it can be informed to the user through vibrations. Further, if a user determines that the moving speed is too high to obtain images for post processing, photographing may be automatically suspended.

As described above, the proper camera moving speed is informed to a user to thereby obtain a proper amount of moving images and prevent the post-processing time from increasing. Further, it is possible to obtain a composite image of proper size through post-processing, and set an appropriate data storage area of the auxiliary storage 150 for storing the composite image.

If the moving speed is too fast to obtain sufficient information, a user is urged to recapture images by warning beeps or the like. As a result, a user can cancel post-processing if it is difficult to generate a desired composite image even through post-processing. It is possible to eliminate unnecessary processing and save processing time and power consumption.

Further, if the moving speed is low, a photographing period for a desired photography area is increased more than necessary, and in addition, images are captured beyond necessity. As a result, post-processing is elongated. The longer photographing period and post-processing period lead to larger power consumption. This undesirably reduces battery life especially in a small portable device such as a cell phone. In contrast, according to this embodiment, even if the moving speed is below the lower limit of the proper moving speed, the user is urged to recapture images by warning beeps or the like to adjust a captured image amount into an appropriate one, thereby preventing a battery from exhausting.

Incidentally, the photographed area map creating unit 11 may inform a user of at least one of a photographed area shape, overlap of photographed areas, and the locus of a camera that is photographing or has photographed a target area, during or after photography. Since the whole photographed area is displayed during or after photographing of the target area, proper control can be executed without relying on user's memory or hunches.

Further, it is possible to provide a mask image generating unit for displaying a photographed area in outline on all or a part of the display screen in the miniature form during photography as well as after photography (hereinafter referred to as “mask image”). Thus, a proper amount of moving images can be obtained for post-processing during photography.

### Other Embodiments

Incidentally, although the above embodiment describes a method of executing mosaicing processing and super-resolution processing after capturing moving images. That is, moving images are captured independently, and after the completion of capturing moving images, mosaicing processing and super-resolution processing are executed. According to this method, a user needs to waits for a while until the post-processing is completed. If a high processor speed is secured, mosaicing processing and super-resolution processing may be executed while moving images are captured. If the moving images are captured in parallel to post-processing, a user can obtain a result of mosaicing processing and super-resolution processing substantially at the completion of capturing moving images or more quickly than a general post processing does. In this case as well, similar to the above embodiment, a photographed area may be displayed or abnormal moving speed is informed during photography to thereby provide a user with support information for obtaining a proper composite image.

Further, in the above embodiment, a photographed area is displayed or a moving speed is detected based on motion information in the image compressing unit 120, but the photographing device may capture and store moving images in an uncompressed form. In this case, a motion detecting unit may be separately provided to display a photographed area or detect a moving speed. Further, in this embodiment, a photographed area or moving speed is informed so as to obtain an appropriate overlap throughout the entire target area because the obtained image is subjected to post-processing such as mosaicing processing and super-resolution processing. However, the other image synthesizing processing can be carried out. In this case, a photographed area or camera moving speed may be informed so as to assist a user to photograph an area necessary for the image synthesizing processing.

Further, the above embodiment describes the hardware components. However, the invention is not limited thereto, and processing of each block can be also performed by a CPU (Central Processing Unit) executing a computer program. In this case, the computer program can be recoded on a recording medium and provided or transferred through the Internet or such other transfer media.

It is apparent that the present invention is not limited to the above embodiment that may be modified and changed without departing from the scope and spirit of the invention.

What is claimed is:

1. A camera phone, comprising:
a camera capturing an image;
a motion detecting unit detecting a moving speed of the camera phone upon capturing images to generate a composite image; and
an informing unit informing a user of a detecting result from the motion detecting unit,
the camera phone capturing the images to generate the composite image.

2. The camera phone according to claim 1, wherein the informing unit informs the speed detection result at least one of during and after capturing the images.

3. The camera phone according to claim 1, wherein the informing unit informs a user of the detection result if a speed detected with the motion detecting unit is higher than a preset upper limit or lower than a preset lower limit.

4. The camera phone according to claim 2, wherein the informing unit informs a user of the detection result if a speed detected with the motion detecting unit is higher than a preset upper limit or lower than a preset lower limit.

5. The camera phone according to claim 1, wherein the motion detecting unit detects the moving speed of the camera phone based on X-directional displacement and Y-directional displacement derived from two consecutive images.

6. The camera phone according to claim 2, wherein the motion detecting unit detects the moving speed of the camera phone based on X-directional displacement and Y-directional displacement derived from two consecutive images.

7. The camera phone according to claim 3, wherein the motion detecting unit detects the moving speed of the camera phone based on X-directional displacement and Y-directional displacement derived-from two consecutive images.

8. The camera phone according to claim 1, further comprising:
an image compressing unit compressing an image based on motion information derived from two consecutive images,
the motion detecting unit detecting a moving speed of the camera phone based on the motion information from the image compressing unit.

9. The camera phone according to claim 2, further comprising:
an image compressing unit compressing an image based on motion information derived from two consecutive images,
the motion detecting unit detecting a moving speed of the camera phone based on the motion information from the image compressing unit.

10. The camera phone according to claim 3, further comprising:
an image compressing unit compressing an image based on motion information derived from two consecutive images,
the motion detecting unit detecting a moving speed of the camera phone based on the motion information from the image compressing unit.

11. The camera phone according to claim 4, further comprising:
an image compressing unit compressing an image based on motion information derived from two consecutive images,
the motion detecting unit detecting a moving speed of the camera phone based on the motion information from the image compressing unit.

12. The camera phone according to claim 1, wherein the composite image is generated based on an area wider than an angle of view of the camera.

13. The camera phone according to claim 2, wherein the composite image is generated based on an area wider than an angle of view of the camera.

14. The camera phone according to claim 3, wherein the composite image is generated based on an area wider than an angle of view of the camera.

15. The camera phone according to claim 1, wherein the images are moving images.

16. The camera phone according to claim 1, further comprising:
a mosaicing processing unit generating a mosaic image based on the images.

17. The camera phone according to claim 2, further comprising:
a mosaicing processing unit generating a mosaic image based on the images.

18. The camera phone according to claim 3, further comprising:
a mosaicing processing unit generating a mosaic image based on the images.

19. The camera phone according to claim 16, further comprising:
a super-resolution processing unit generating a super-resolution image based on the images.

20. A photography support method used for a camera phone, comprising:
detecting a moving speed of the camera phone upon capturing images to generate a composite image; and
informing a user of the detection result,
the method capturing the images to generate the composite image.
